(19) United States
(12) Patent Application Publication
(10) Pub. No.: US 2025/0315812 A1
(43) Pub. Date: Oct. 9, 2025

(54) Tokenized Pre-Transaction Account Combination

(71) Applicant: American Express Travel Related Services Company, Inc., New York, NY (US)

(72) Inventor: Alaric M. Eby, Scottsdale, AZ (US)

(21) Appl. No.: 18/629,144

(22) Filed: Apr. 8, 2024

(51) Int. Cl. G06Q 20/22; G06Q 20/20; G06Q 20/32; G06Q 20/34

(52) U.S. Cl. CPC G06Q 20/227; G06Q 20/204; G06Q 20/3278; G06Q 20/351

(57) ABSTRACT

Disclosed are various embodiments for the tokenized combination of accounts prior to a transaction. A first account identifier is obtained for a first transaction card. Then, a split transaction account creation request is sent to a split transaction service, the split transaction account creation request comprising the first account identifier representing the first transaction card and a second account identifier representing a second transaction card. A split transaction token is received from the split transaction service, the split transaction token representing a virtualized transaction card for use in a transaction. Subsequently, the split transaction token is provided to a point-of-sale (PoS) device to complete a transaction.

### BACKGROUND

Often times, individuals desire to split the cost of a purchase. For example, a group of friends may wish to split the cost of a tank of gas or dinner at a restaurant. Similarly, a group of friends or family members may wish to split the cost of a large, share purchase (e.g., an appliance for use at home). Accordingly, a single person may make the purchase, in which case he or she is responsible for collecting reimbursement after the fact or demanding payment in advance. This can potentially require the individual to accept reimbursement or pre-payment at different times than when the transaction occurs or using different payment methods than what is used for the transaction.

Moreover, the individuals sharing the cost of the purchase may lose out on the benefits of using particular payment instruments. For example, the person making the purchase with his or her credit card may get the benefit of extra rewards points or cash back, while those reimbursing the purchaser fail to accrue those benefits.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing depicting one of several embodiments of the present disclosure.

FIG. 3 is a drawing depicting one of several embodiments of the present disclosure.

FIG. 4 is a drawing of a network environment according to various embodiments of the present disclosure.

FIG. 5 is a flowchart illustrating one example of functionality implemented the network environment of FIG. 4 according to various embodiments of the present disclosure.

FIG. 6 is a flowchart illustrating one example of functionality implemented the network environment of FIG. 4 according to various embodiments of the present disclosure.

FIG. 7 is a flowchart illustrating one example of functionality implemented the network environment of FIG. 4 according to various embodiments of the present disclosure.

### DETAILED DESCRIPTION

Disclosed are various approaches for combining or linking multiple payment instruments into a single payment instrument prior to making a purchase or performing a transaction. A user can collect payment information from multiple payment instruments using a digital wallet application on his or her mobile device (e.g., smartphone, tablet, wearable, etc.). A virtualized payment instrument is then created and linked to the multiple payment instruments. The virtualized payment instrument can be presented to merchants for use as payment in a transaction, and the cost of the transaction can be split an allocated to the multiple linked payment instruments. The virtualized payment instrument can be used with any pre-existing point of sale (POS) device and used with existing payment rails (e.g., existing credit or debit card networks).

The various embodiments of the present disclosure address a number of technical problems related to payments and payment processing. First, many attempts at addressing split transactions involve modifying the point of sale (PoS) device, modifying post-transaction flows, or modifying transaction authorization negotiations. For example, individuals may be required to provide multiple payment instruments (e.g., multiple credit cards or gift cards) to a merchant, which can result in higher transaction costs for the merchant and requires the PoS device to support accepting multiple payment instruments for a single transaction. In some instances, users may be required to expose physical cards to the merchant, which is a security risk by providing unscrupulous actors the opportunity to copy or clone the physical payment card. As another example, individuals may be required to split the transaction after it occurs, which places the burden on the payer to seek reimbursement if others are non-responsive or fail to use the same payment platform. The risks to the user (e.g., risk of lack of support by the POS device, fraud risk, and repayment risk) have inhibited or prevented the adoption of technologies which allow for users to easily and seamlessly split a payment or the cost of a transaction.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

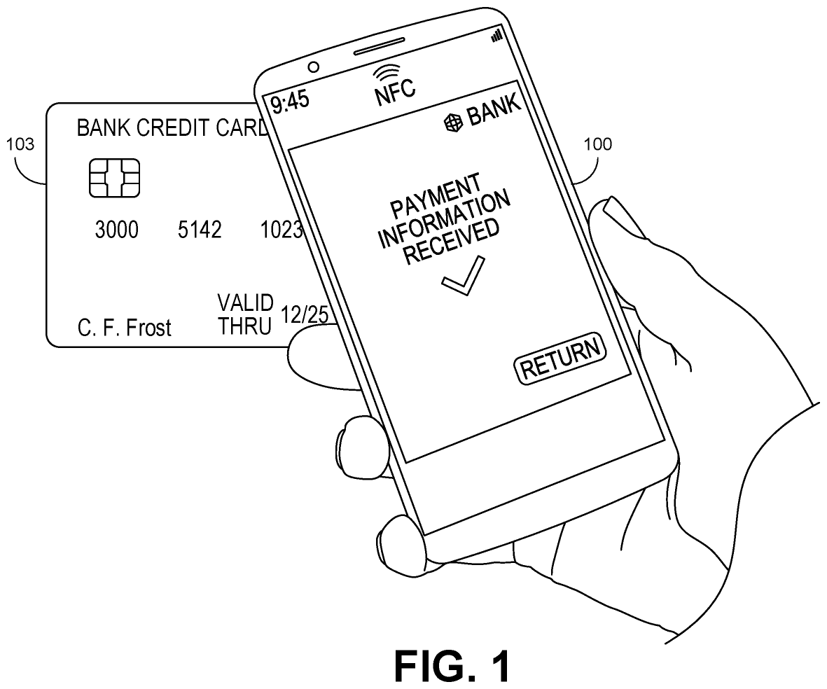

FIG. 1 depicts a first example of how a user could obtain information about a transaction account (e.g., credit card account information) using a digital wallet on his or her mobile device 100. As shown, a user can place his or her mobile device 100 in proximity to a payment card 103 (e.g., a charge card, credit card, or debit card). A near-field communication (NFC) reader on the mobile device 100 can read the payment account information from the payment card 103 using the NFC reader and store it on the mobile device 100 for use in splitting a payment. Once the user has collected the payment account information for multiple payment cards 103, the user could use the NFC reader of his or her mobile device 100 to make a payment with an NFC enabled PoS device by using a virtualized payment account that is compatible with the existing PoS device and payment system.

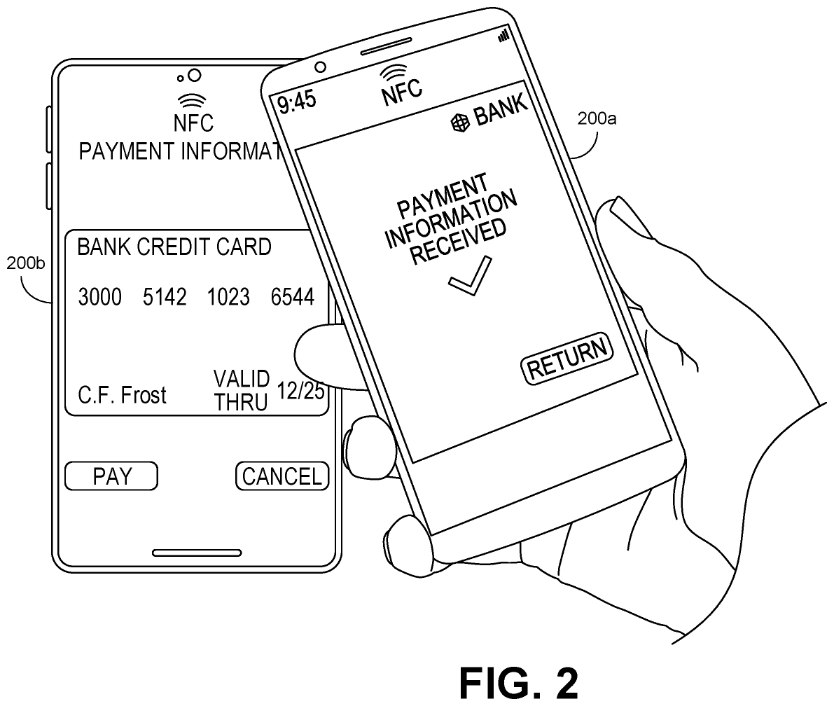

FIG. 2 depicts a second example of how a user could obtain information about a transaction account (e.g., credit card account information) using a digital wallet on his or her mobile device 200a. As shown, a user can place his or her mobile device 100 in proximity to a second mobile device 200b with a digital wallet application also installed and NFC reader enabled. The first digital wallet application installed on the first mobile device 200a could use its NFC reader to communicate with the second digital wallet application installed on the second mobile device 200b to obtain the payment account information for a payment account (e.g., charge card, credit card, or debit card) stored by the second digital wallet on the second mobile device 200b. Once the user has collected the payment account information for multiple payment accounts, the user could use the NFC reader of his or her mobile device 200a to make a payment with an NFC enabled PoS device by using a virtualized payment account that is compatible with the existing PoS device and payment system.

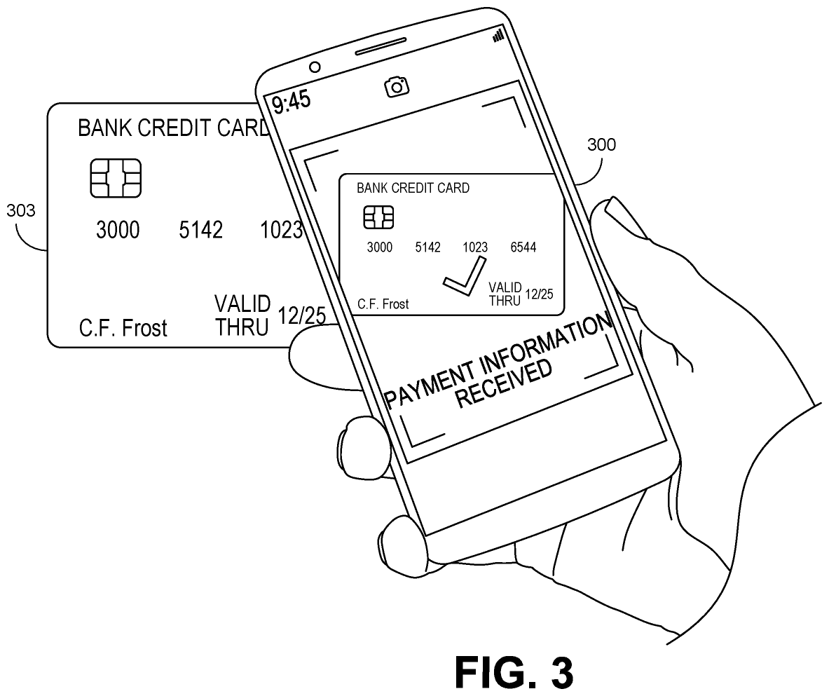

FIG. 3 depicts a first example of how a user could obtain information about a transaction account (e.g., credit card account information) using a digital wallet on his or her mobile device 300. As shown, a user can use his or her mobile device 100 to take a picture of a payment card 303 (e.g., a charge card, credit card, or debit card). Various image processing techniques, such as optical character recognition (OCR) could be used to identify the payment account information printed on the payment card from the image of the payment card. Once the user has collected the payment account information for multiple payment cards 103, the user could use the NFC reader of his or her mobile device 100 to make a payment with an NFC enabled PoS device by using a virtualized payment account that is compatible with the existing PoS device and payment system.

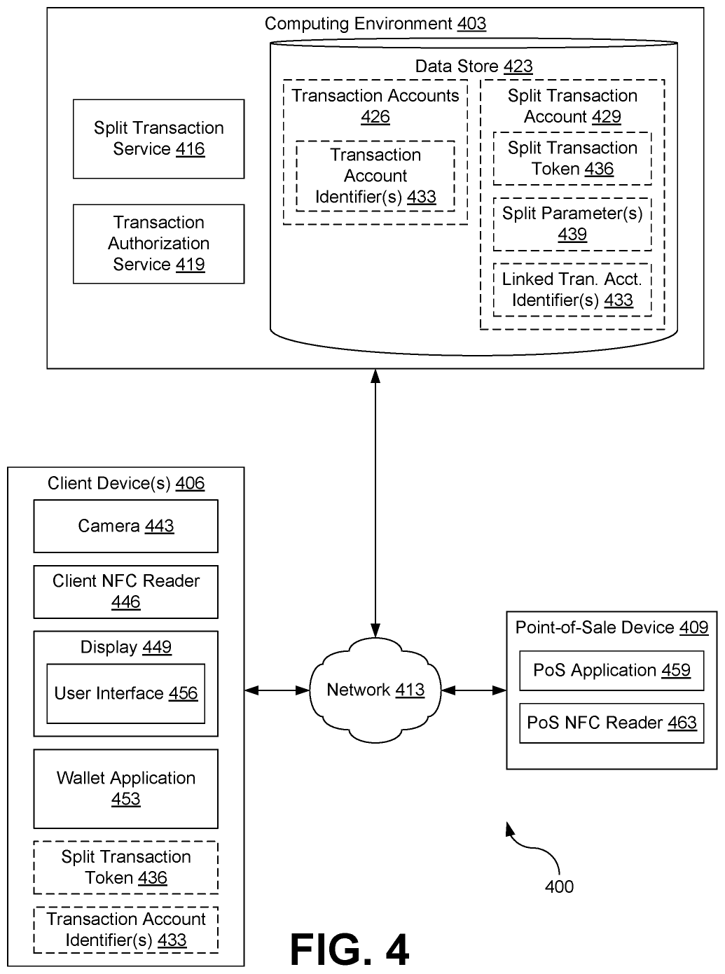

With reference to FIG. 4, shown is a network environment 400 according to various embodiments. The network environment 400 can include a computing environment 403, a client device 406, and a Point-of-Sale (POS) device 409, which can be in data communication with each other via a network 413.

The network 413 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 413 can also include a combination of two or more networks 413. Examples of networks 413 can include the Internet, intranets, extranets, virtual private networks (VPNs), and similar networks.

Moreover, the client device 406 and the POS device 409 can be in direct communication with each other via a wireless connection or personal area network (PAN). For example, the client device 406 and the POS device 409 could be configured to communicate with each other using near field communication (NFC), ultrawide band (UWB), or similar low energy, short range wireless communication mechanisms. For the purposes of the present disclosure, such direct wireless connection and communication between a client device 406 and a PoS device 409 can be considered to occur across the network 413.

The computing environment 403 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 403 can employ a plurality of computing devices that can be arranged in one or more server banks or computer banks or other arrangements. Such computing devices can be located in a single installation or can be distributed among many different geographical locations. For example, the computing environment 403 can include a plurality of computing devices that together can include a hosted computing resource, a grid computing resource or any other distributed computing arrangement. In some cases, the computing environment 403 can correspond to an elastic computing resource where the allotted capacity of processing, network, storage, or other computing-related resources can vary over time.

Various applications or other functionality can be executed in the computing environment 403. The components executed on the computing environment 403 include a split transaction service 416, a transaction authorization service 419, and other applications, services, processes, systems, engines, or functionality not discussed in detail herein.

Also, various data is stored in a data store 423 that is accessible to the computing environment 403. The data store 423 can be representative of a plurality of data stores 423, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 423 is associated with the operation of the various applications or functional entities described below. This data can include one or more transaction accounts 426, one or more split transaction accounts 429, and potentially other data.

A transaction account 426 can represent a payment account used for making payments for goods or services. One example of a transaction account can include a demand deposit accounts (DDAs), such as a checking, savings, or money market account. Funds within a DDA could be accessed or used for payments using a debit card. Another example of a transaction account is a credit or charge account, which allows an individual to make purchases on credit with a promise to repay the issuer or lender at later time. Payments could be made using a credit or charge account using a credit card or charge card.

Each transaction account 426 could be identified by one or more transaction account identifiers 433. A transaction account identifier 433 is a unique identifier with respect to other transaction account identifiers 433 that can be used to identify individual transaction accounts 426. For example, a checking account could have a first transaction account identifier 433 such as a bank account number and a second transaction account identifier 433 such as a debit card number for a debit card associated with the checking account. As another example, a credit or charge account could have a transaction account identifier 433 such as a credit card number or charge card number that identifies the credit or charge account.

A split transaction account 429 can represent virtual transaction account used for payments that are to be split between multiple transaction accounts 426. A split transaction account 429 can include a split transaction token 436, one or more split parameters 439, and one or more linked transaction account identifiers 433.

The split transaction token 436 is a unique identifier with respect to other split transaction tokens 436 and transaction account identifiers 433, which can be used to identify the split transaction account 429 when the split transaction account 429 is used for making a payment. To facilitate payments, a split transaction token 436 may be formatted to comply with the requirements specified by the payment rail for which the split transaction account 429 will be used to make a purchase or payment. For example, if the split transaction account 429 were to be used to make a purchase using a credit card network payment rail (e.g., the VISA, MASTERCARD, AMERICAN EXPRESS, or DISCOVER networks), then the split transaction token 436 could be formatted to comply with the requirements of the ISO/IEC 7812 standard, which specifies the format of the issuer identification number and primary account number that, in combination, form the account number issued to a credit card, charge card, or debit card. Accordingly, in some implementations, the split transaction token 436 could be referred to as a virtual card number, a tokenized card number, etc. In some instances, the split transaction token could also include an expiration date and/or a card security code (CSC) or care verification value (CVV), which could allow the split transaction account 429 to be used in situations where those additional items of data are required.

The split parameters 439 represent individual parameters, rules, or policies for how to split a payment between the transaction accounts 426 linked to the split transaction account 429. A split parameter 439 could, for example, specify a ratio between the linked or associated transaction accounts 426 for funding a transaction paid using the split transaction account 429. As another example, a split parameter 439 could specify a maximum permitted amount for a purchase made using the split transaction account 429 or a maximum permitted amount to be charged to an individual transaction account 426 linked to the split transaction account 429.

The linked transaction account identifiers 433 are the transaction account identifiers 433 of transaction accounts 426 used to fund purchases made with the split transaction account 429. As previously discussed, the linked transaction account identifiers 433 can include bank account numbers, charge card numbers, credit card numbers, debit card numbers, etc.

The split transaction service 416 can be executed to generate split transaction accounts 429. For example, in response to receiving a split transaction account creation request, the split transaction service 416 can create a split transaction account 429. This can include generating a split transaction token 436 for the split transaction account 429 and storing one or more split parameters 439 and linked transaction account identifiers 433 in association with the split transaction account 429. The split parameters 439 and linked transaction account identifiers 433 could be included in the split transaction account creation request in some instances. In other instances, a default split parameter 439 or a default linked transaction account identifier 433 could be saved with the split transaction account 429.

The transaction authorization service 419 can be executed to authorize transactions made using a transaction account 426 or a split transaction account 429. When a transaction authorization request is received from a PoS device 409, the transaction authorization service 419 can evaluate the transaction for compliance with various credit, fraud, or risk checks. If the transaction complies with the various credit, fraud, or risk checks, then the transaction can be authorized, resulting in the merchant associated with the POS device 409 being paid by the issuer of the transaction account 426 or the split transaction account 429.

The client device 406 is representative of a plurality of client devices that can be coupled to the network 413. The client device 406 can include a processor-based system such as a computer system. Such a computer system can be embodied in the form of a personal computer (e.g., a desktop computer, a laptop computer, or similar device), a mobile computing device (e.g., cellular telephones, smartphones, tablet computer systems, and similar devices), or other devices with like capability. Accordingly, the client device 406 can include components such as a camera 443, a near field communication (NFC) reader 446, and one or more displays 449, such as liquid crystal displays (LCDs), gas plasma-based flat panel displays, organic light emitting diode (OLED) displays, electrophoretic ink (“E-ink”) displays, projectors, or other types of display devices. In some instances, the display 449 can be a component of the client device 406 or can be connected to the client device 406 through a wired or wireless connection.

The client device 406 can be configured to execute various applications such as a wallet application 453, mobile banking applications, or other applications. The wallet application 453 can be executed by a client device 406 to allow a user to make payments with the PoS device 409. Accordingly, the wallet application 453 can store one or more transaction account identifiers 433 of transaction accounts 426 associated with the user of the client device 406 and one or more split transaction tokens 436 issued to the client device 406. The wallet application 453 can also allow a user to select a transaction account 426 or split transaction account 429 for payment. Moreover, the wallet application 453 can allow a user to obtain transaction account identifiers 433 of other individuals for use with a split transaction account 429 as discussed later. In some implementations, the wallet application 453 could be a standalone application (e.g., APPLE WALLET, GOOGLE WALLET, etc.) or it could be included as a component of another application such as a mobile banking application or financial services application installed on the client device 406. In order to implement the functionality described herein, the wallet application 453 may cause a user interface 456 on the display 449.

The PoS device 409 can represent any device that processes purchases or transactions made by individual customers. For example, the POS device 409 could be used to process a payment made using a payment or transaction card (e.g., a charge, credit, debit, gift, or stored-value card) by sending a request for authorization for the payment to the transaction authorization service 419. The request for authorization could include a cryptogram generated using a version of the Europay-Mastercard-Visa Company (EMVCo) standard, where the cryptogram represents a transaction account 426 or a split transaction account 429. The request for authorization could include additional information, such as the expiration date of the card, billing address for the card, card security code (CSC) or card verification value (CVV) for the card, etc.

The PoS device 409 could be implemented in a number of manners. For example, the PoS device 409 could be a dedicated terminal configured with an EMV chip reader, a magnetic stripe reader, and/or an NFC reader, such as the POS NFC reader 463. The terminal could be portable, handheld, or a fixed device. In some implementations, a PoS device 409 could be an accessory device physically or wirelessly connected to a general-purpose computing device (e.g., a mobile phone, tablet, laptop, desktop, or other personal computer). The accessory device could be configured with an EMV chip reader, a magnetic stripe reader, and/or an NFC reader, such as the POS NFC reader 463. In other implementations, the PoS device 409 could be a general-purpose computing device, such as a mobile phone or tablet that includes an NFC reader, such as the POS NFC reader 463.

The PoS device 409 could include or a PoS application 459, which can be executed to cause the POS device 409 to perform the various functions needed to process a payment and/or request authorization for a transaction. For example, a dedicated terminal could include a PoS application 459 to facilitate the use of the terminal and perform the various payment processing and authorization actions. As another example, the general-purpose computing device (e.g., the mobile phone, tablet, laptop, desktop, or other personal computer) could include a PoS application 459 to allow the general-purpose computing device to use the accessory PoS device 409 connected to the general-purpose computing device.

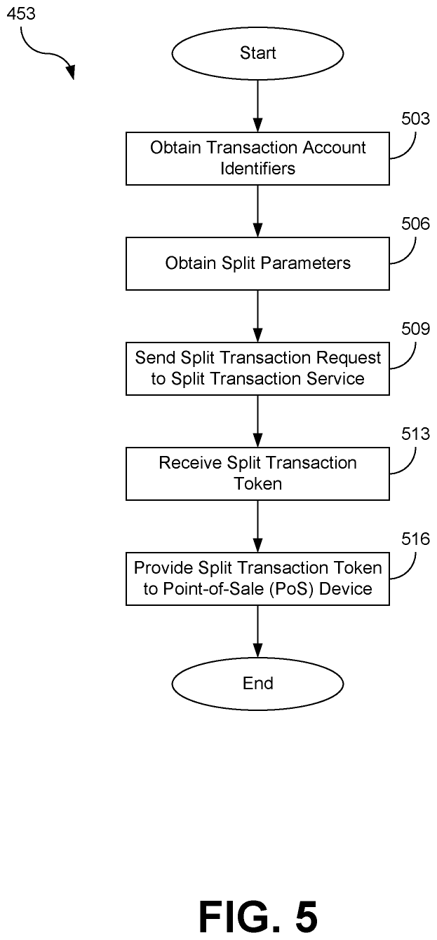

Referring next to FIG. 5, shown is a flowchart that provides one example of the operation of a portion of the wallet application 453. The flowchart of FIG. 5 provides merely an example of the many different types of functional arrangements that can be employed to implement the operation of the depicted portion of the wallet application 453. As an alternative, the flowchart of FIG. 5 can be viewed as depicting an example of elements of a method implemented within the network environment 400.

Beginning with block 503, the wallet application 453 can obtain transaction account identifiers 433 for multiple transaction accounts 426 that a payment or transaction will be split between. For example, a user of the client device 406 could select his or her personal transaction account 426 from a list of transaction accounts 426 presented by the wallet application 453 within the user interface 456 shown on the display 449. In addition, the user of the client device 406 could obtain respective transaction account identifiers 433 for one or more respective transaction accounts 426. For example, an NFC enabled payment or transaction card could be placed in proximity to the client device 406, thereby allowing the wallet application 453 to use the NFC reader 446 of the client device 406 to obtain the transaction account identifier 433 of the transaction account 426 associated with the payment or transaction card. As another example, another NFC enabled client device 406 could be placed in proximity to the client device 406, thereby allowing the wallet application 453 to use the NFC reader 446 of the client device 406 to obtain the transaction account identifier 433 of a transaction account 426 stored on the other client device 406 (e.g., by communicating with another wallet application 453 executed by the other client device 406). In a third example, the wallet application 453 could cause the client device 406 to capture an image of a payment or transaction card using the camera 443 of the client device 406. The wallet application 453 could then use various image processing and text recognition techniques (e.g., optical character recognition (OCR)) to identify the transaction account identifier 433 of the transaction account 426 associated with the payment or transaction card. These examples are also previously illustrated in FIGS. 1-3 and described in the accompanying paragraphs.

Next, at block 506, the wallet application 453 can obtain one or more split parameters 439. For example, the wallet application 453 could present within the user interface one or more prompts, dialog boxes, sliders, text inputs, or other user interface elements or user input features. The user of the client device 406 could then provide one or more split parameters 439 to the wallet application 453 through the user interface 456. For example, the user could provide a split ratio that describes how much of a purchase or transaction to apply to a specific transaction account 426. For instance, a user could specify a first percentage of the amount be allocated to a first transaction account 426, a second percentage of the amount be allocated a second transaction account 426, and a third percentage of the amount be allocated to a third transaction account 426. As another example, the user could provide limits, such as a maximum amount for any payment or transaction using the split transaction account 429 or a maximum amount or limit that could be allocated to any linked or associated transaction account 426. In a third example, the user could provide a limit on the number of times the split transaction account 429 could be used (e.g., for a single transaction, for a defined number of transactions, or for an unlimited number of transactions) or a limit on how long the split transaction account 429 is valid to use in a transaction (e.g., valid for one hour, one day, multiple days, weeks, months, or for an unlimited amount of time). In a fourth example, the user could provide a limit on the type of transaction for which the split transaction account 429 could be used. For instance, the user could select one or more types of merchants (e.g., gas stations, utilities, restaurants, grocery stores, drug stores, etc.) with whom the split transaction account 429 can be used. Other types of split parameters 439 could also be specified by the user, and therefore obtained by the wallet application 453, according to various embodiments of the present disclosure.

Moving on to block 509, the wallet application 453 can send a split transaction account creation request to the split transaction service 416. The split transaction account creation request can represent a request to create a split transaction account 429. Accordingly, the split transaction account creation request can include the transaction account identifiers 433 of the transaction accounts 426 that will be associated with or linked to the split transaction account 429. The split transaction account creation request can also include one or more split parameters 439 for the split transaction account 429.

Proceeding to block 513, the wallet application 453 can receive a split transaction token 436 from the split transaction service 416 in response to sending the split transaction account creation request at block 509. As previously discussed, the split transaction token 436 can represent the split transaction account 429 created by the split transaction service 416 in response to the wallet application 453 sending the split transaction account creation request at block 509.

Subsequently, at block 516, the wallet application 453 can provide the split transaction token 436 to a PoS device 409 to perform a payment or complete a transaction. For example, a user of the client device 406, as part of a payment process, could place his or her client device 406 in proximity to the POS device 409. The wallet application 453 could then prompt, within the user interface 456, for the user to select the split transaction account 429 for payment. Once selected, the wallet application 453 could provide the split transaction token 436 to the POS device 409. For example, the wallet application 453 could cause the client device 406 to send the split transaction token 436 to the PoS device 409 using the client NFC reader 446. The POS NFC reader 463 could receive the split transaction token 436 and provided it to the PoS application 459 for use in completing the payment or transaction authorization request.

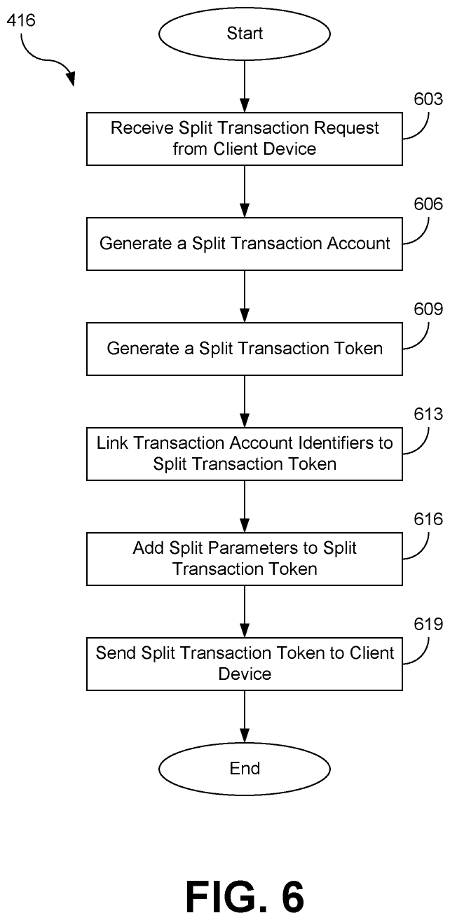

Referring next to FIG. 6, shown is a flowchart that provides one example of the operation of a portion of the split transaction service 416. The flowchart of FIG. 6 provides merely an example of the many different types of functional arrangements that can be employed to implement the operation of the depicted portion of the split transaction service 416. As an alternative, the flowchart of FIG. 6 can be viewed as depicting an example of elements of a method implemented within the network environment 400.

Beginning with block 603, the split transaction service 416 can receive a split transaction account creation request from a client device 406. For example, a wallet application 443 executing on the client device 406 could send a split transaction account creation request, as previously illustrated at block 509 of FIG. 5. Such a split transaction account creation request could be received by the split transaction service 416 at block 603.

Then, at block 606, the split transaction service 416 can generate or create a split transaction account 429 in response to receiving the split transaction account creation request. The split transaction account 429, as previously described, can be used to make or complete a purchase or transaction using existing payment rails (e.g., existing credit card payment networks). The split transaction account 429 can be processed by the POS device 409 or PoS application 459 as if it were a transaction account 426, with the splitting of the amounts owed handled by the transaction authorization service 419.

Next, at block 609, the split transaction service 416 can generate a split transaction token 436. The split transaction token 436 could be used to represent the split transaction account 429 in transactions. Accordingly, the split transaction token 436 could be created and formatted to comply with the requirements of the ISO/IEC 7812 standard, which specifies the format of the issuer identification number and primary account number that, in combination, form the account number issued to a credit card, charge card, or debit card. In some instances, the split transaction token could also include an expiration date and/or a card security code (CSC) or care verification value (CVV), which could allow the split transaction account 429 to be used in situations where those additional items of data are required. Once created, the split transaction service 416 can save the split transaction token 436 to the split transaction account 429 generated at block 606.

Moving on to block 613, the split transaction service 416 can link any transaction account identifiers 433 included in the split transaction account creation request to the split transaction account 429 created at block 606. These transaction account identifiers 433 could be saved as linked transaction account identifiers 433 associated with the split transaction account 429.

Proceeding to block 616, the split transaction service 416 can add to or include in the split transaction account 429 created at block 606 one or more split parameters 439. The split transaction parameters 439 could be obtained by evaluating the split transaction account creation request received at block 603 and including the split transaction parameters 439 that were specified in the split transaction account creation request.

Subsequently, at block 619, the split transaction service 416 can sent the split transaction token 436 to the client device 406. For example, the split transaction token 436 could be sent to the wallet application 443 as a response to the split transaction account creation request received at block 606.

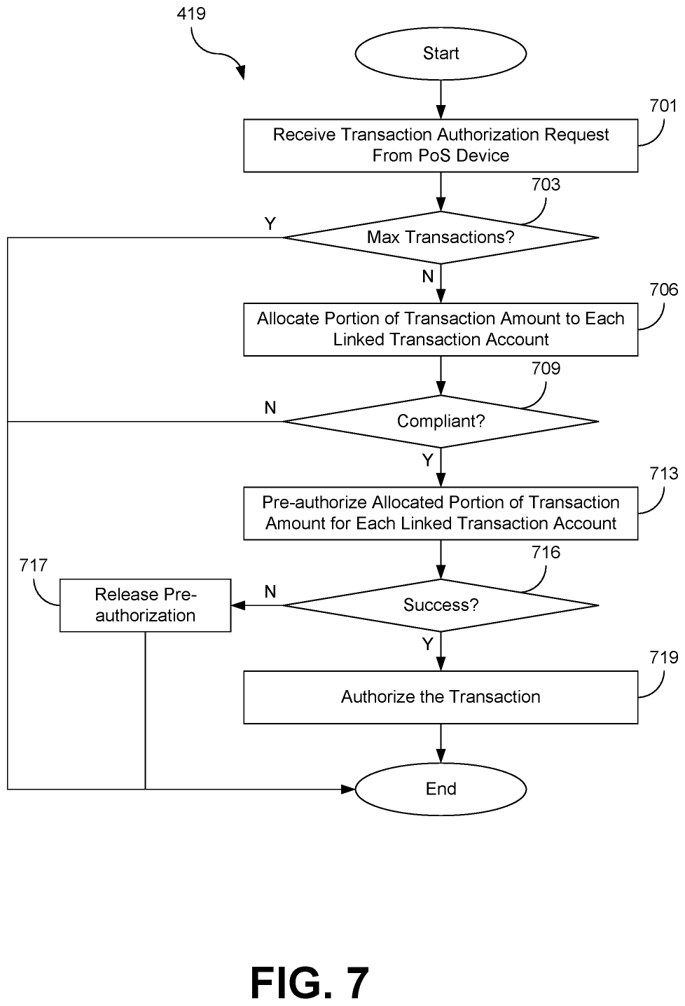

Referring next to FIG. 7, shown is a flowchart that provides one example of the operation of a portion of the transaction authorization service 419. The flowchart of FIG. 7 provides merely an example of the many different types of functional arrangements that can be employed to implement the operation of the depicted portion of the transaction authorization service 419. As an alternative, the flowchart of FIG. 7 can be viewed as depicting an example of elements of a method implemented within the network environment 400.

Beginning with block 701, the transaction authorization service 419 can receive a transaction authorization request from a PoS device 409. For example, the PoS application 459 could cause the PoS device 409 to send a transaction authorization request using an existing credit, debit, or charge card payment rail in order to complete a payment or transaction made using the wallet application 443 of the client device 406. The transaction authorization request could include, for example, the split transaction token 436 or a cryptogram representing the split transaction token 436 or split transaction account 429, an amount for the transaction, the identity of the operator of the POS Device 409 (e.g., the name of the merchant and the classification of the merchant), and/or other data.

Next, at block 703, the transaction authorization service 419 can check to determine if the split transaction account 429 has exceeded an authorized number of transactions after the transaction was authorized at block 719. For example, if the split transaction account 429 has a split parameter indicating it can only be used for a single transaction or for a limited number of transactions, the transaction authorization service 419 could determine if the most recent transaction exceeds the allowed number of transactions specified by the split parameter. If the number of times that the split transaction account 429 exceeds the specified maximum number of transactions, then the process can end. However, if the number of times that the split transaction account 429 remains less than the specified maximum number of transactions, then the process can proceed to block 706.

Then, at block 706, the transaction authorization service 419 can allocate a portion of the transaction amount specified in the transaction authorization request to each linked transaction account 426. For example, the transaction authorization service 419 could evaluate and compare the split parameters 439 with the linked transaction account identifiers 433 associated with the split transaction account 429 specified in the transaction authorization request to determine an amount to allocate or assign to each respective transaction account 426.

Proceeding to block 709, the transaction authorization service 419 can determine whether the allocation of the individual amounts to the respective transaction accounts 426 complies with one or more split parameters 439. For example, the transaction authorization service 419 could determine whether any allocated amount to a respective transaction account 426 exceeds a limit or value specified by a split parameter 439. For instance, the transaction authorization service 419 could determine whether an amount allocated to a respective transaction account 426 exceeds a specified amount or limit, a specified amount or limit for a particular type or category of merchant, etc. If the allocation complies with the split parameters 439, then the process can proceed to block 713. Otherwise, the process could fail and the transaction could be declined by the transaction authorization service 419.

Moving on to block 713, the transaction authorization service 419 can pre-authorize the portion or amount of the transaction allocated to each transaction account 426 linked to the split transaction account 429. The pre-authorization process can be done to ensure that each transaction account 426 linked to the split transaction account 429 has sufficient funds, credit, or purchasing power or ability for the allocated portion or amount of the transaction. Moreover, the pre-authorization process can place a hold on the transaction account 426 for an amount equal to the allocated amount to ensure that the funds remain available to cover the split transaction as the authorization process continues.

At block 716, the transaction authorization service 419 can confirm whether the pre-authorizations were successful. If one or more of the pre-authorizations fail, then the process can proceed to block 717. However, if all of the pre-authorizations are successful, then the process can proceed to block 719.

If the process proceeds to block 717, then the transaction authorization service 419 can release the pre-authorizations for each of the respective transaction accounts 426 linked to the split transaction account 429. The funds, credit, or purchasing power then becomes available again to the respective transaction accounts 426 for other purposes or purchases.

However, if the process proceeds to block 719, the transaction authorization service 419 can authorize the transaction. For example, the transaction authorization service 419 could send a post-authorization or a settlement message to each of the respective transaction accounts 426 linked to the split transaction account 429. This could cause funds to be withdrawn from the linked transaction accounts 426 and transferred to the split transaction account 429. The transaction authorization service 419 could then send a response to the transaction authorization request received at block 703 to indicate that the transaction has been authorized. Moreover, the transaction authorization service 419 could cause the funds withdrawn from the linked transaction accounts 426 to be transferred to the merchant or acquiring account associated with the merchant operating the POS device 409.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain a first account identifier for a first transaction card;
send a split transaction account creation request to a split transaction service, the split transaction account creation request comprising the first account identifier representing the first transaction card and a second account identifier representing a second transaction card;
receive a split transaction token from the split transaction service, the split transaction token representing a virtualized transaction card for use in a transaction; and
provide the split transaction token to a point-of-sale (POS) device to complete a transaction.

2. The system of claim 1, wherein the computing device further comprises a near field communication (NFC) reader and the machine-readable instructions that cause the computing device to obtain the first account identifier for the first transaction card further cause the computing device to at least read the first account identifier from the first transaction card using the NFC reader.

3. The system of claim 1, wherein the computing device is a first computing device that further comprises a near field communication (NFC) reader and the machine-readable instructions that cause the first computing device to obtain the first account identifier for the first transaction card further cause the first computing device to at least read the first account identifier for the first transaction card from a second computing device using the NFC reader of the first computing device.

4. The system of claim 1, wherein the computing device further comprises a camera and the machine-readable instructions that cause the computing device to obtain the first account identifier for the first transaction card further cause the computing device to at least:
obtain an image of the first transaction card; and
perform optical character recognition (OCR) on the image of the first transaction card to obtain the first account identifier from the first transaction card.

5. The system of claim 1, wherein the machine-readable instructions further cause the computing device to at least:
present a set of transaction cards to a user of the computing device, the set of transaction cards including the second transaction card; and
obtain a selection of the second transaction card from the set of transaction cards.

6. The system of claim 1, wherein the machine-readable instructions further cause the computing device to at least:
present an option to the user of the computing device to split the transaction between at least the first transaction card and the second transaction card; and
wherein the machine-readable instructions cause the computing device to obtain the first account identifier from the first transaction card in response to a selection of the option to split the transaction.

7. The system of claim 1, wherein the machine-readable instructions further cause the computing device to at least:
obtain a split parameter; and
include the split parameter in the split transaction account creation request.

8. A method, comprising:
obtaining, using a computing device, a first account identifier for a first transaction card;
sending, using the computing device, a split transaction account creation request to a split transaction service, the split transaction account creation request comprising the first account identifier representing the first transaction card and a second account identifier representing a second transaction card;
receiving, using the computing device, a split transaction token from the split transaction service, the split transaction token representing a virtualized transaction card for use in a transaction; and
providing, using the computing device, the split transaction token to a point-of-sale (PoS) device to complete a transaction.

9. The method of claim 8, wherein the computing device further comprises a near field communication (NFC) reader and obtaining the first account identifier for the first transaction card further comprises reading the first account identifier from the first transaction card with the NFC reader.

10. The method of claim 8, wherein the computing device is a first computing device that further comprises a near field communication (NFC) reader and obtaining the first account identifier for the first transaction card further comprises reading the first account identifier for the first transaction card from a second computing device using the NFC reader of the first computing device.

11. The method of claim 8, wherein the computing device further comprises a camera and obtaining the first account identifier for the first transaction card further comprises:
obtaining an image of the first transaction card; and
performing optical character recognition (OCR) on the image of the first transaction card to obtain the first account identifier from the first transaction card.

12. The method of claim 8, further comprising:
presenting a set of transaction cards to a user of the computing device, the set of transaction cards including the second transaction card; and
obtaining a selection of the second transaction card from the set of transaction cards.

13. The method of claim 8, further comprising:
present an option to the user of the computing device to split the transaction between at least the first transaction card and the second transaction card; and
wherein the machine-readable instructions cause the computing device to obtain the first account identifier from the first transaction card in response to a selection of the option to split the transaction.

14. The method of claim 8, further comprising:
obtaining a split parameter; and
including the split parameter in the split transaction account creation request.

15. A system, comprising:
a computing device comprising a processor and a memory; and
machine-readable instructions stored in the memory that, when executed by the processor, cause the computing device to at least:
receive a split transaction account creation request from a client application, the split transaction account creation request comprising a first account identifier representing a first transaction card and a second account identifier representing a second transaction card;
generate a split transaction token, the split transaction token representing a virtualized transaction card for use in a transaction;
link the first account identifier and the second account identifier to the split transaction token; and
send the split transaction token to the client device.

16. The system of claim 15, wherein the machine-readable instructions, when executed by the processor, further cause the computing device to at least:
receive, from a point-of-sale (PoS) device, a transaction authorization request for the transaction, the transaction authorization request comprising the split transaction token;
perform a first pre-authorization with the first transaction card for a first portion of the transaction;
perform a second pre-authorization with the second transaction card for a second portion of the transaction; and
authorize the transaction in response to the first pre-authorization and the second pre-authorization.

17. The system of claim 16, wherein the transaction authorization request further comprises a split parameter specifying a ratio for splitting the transaction into at least the first portion and the second portion and the machine-readable instructions, when executed by the processor, further cause the computing device to at least determine a first amount for the first portion of the transaction and a second amount for the second portion of the transaction based at least in part on the split parameter.

18. The system of claim 16, wherein the transaction authorization request further comprises a split parameter specifying a maximum amount for the transaction and the machine-readable instructions, when executed by the processor, further cause the computing device to at least authorize the transaction based at least in part on the split parameter.

19. The system of claim 16, wherein the transaction authorization request further comprises a split parameter specifying a maximum amount for the first portion of the transaction or the second portion of the transaction and the machine-readable instructions, when executed by the processor, further cause the computing device to at least perform the first pre-authorization or the second pre-authorization based at least in part on the first portion of the transaction or the second portion of the transaction satisfying the split parameter.

20. The system of claim 16, wherein the machine-readable instructions, when executed by the processor, further cause the computing device to at least determine that the split transaction token is associated with a split transaction account that has been used with more than a maximum number of transactions.
